(19) United States
(12) Patent Application Publication
(10) Pub. No.: US 2025/0306171 A1
(43) Pub. Date: Oct. 2, 2025

(54) Method For Determining A Target Information Of A Radar Target Based On An Coherent Signal Processing Chain, Radar System And Motor Vehicle

(71) Applicant: Volkswagen Aktiengesellschaft, Wolfsburg (DE)

(72) Inventors: Thomas Gisder, Wolfsburg (DE); Heiko Gustav Kurz, Hannover (DE); Marc-Michael Meinecke, Sassenburg (DE); Renato Simoni, Bonn (DE); María Antonia González-Huici, Bonn (DE); David Mateos-Nunez, Alcala de Henares (ES)

(73) Assignees: Volkswagen Aktiengesellschaft, Wolfsburg (DE); Fraunhofer Gesellschaft zur Föderung der angewandten Forschung e.V., Munich (DE)

(21) Appl. No.: 19/090,498

(22) Filed: Mar. 26, 2025

(30) Foreign Application Priority Data
Mar. 27, 2024 (EP) 24166882.1

(51) Int. Cl. G01S 7/41; G01S 13/48

(52) U.S. Cl. CPC G01S 7/411; G01S 7/418; G01S 13/48

(57) ABSTRACT

The disclosure relates to a method for determining a target information of a target of a radar system, wherein the system comprising transmitting antennas and receiving antennas, wherein each transmitting antenna transmits a radar signal in successive transmission operation, after each transmitting operation, antennas receive signals based on the transmitted signal of the respective transmitting operation, multiple hypothesis of target angles with regards to the radar target are specified, for each hypothesis of a target angle a data structure is generated based on the received signals, for each data structure a range-Doppler-map is generated based on the signals, and the target information is determined based on the range-Doppler-maps. Furthermore the disclosure relates to a radar system and a motor vehicle.

### CROSS-REFERENCE TO RELATED APPLICATIONS

This application claims priority to European Patent Application No. EP 241 668 82.1, filed on Mar. 27, 2024 with the European Patent Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a method for determining at least one target information of at least one radar target of a radar system, wherein the radar system comprising at least one antenna array, which comprises multiple transmitting antennas and multiple receiving antennas.

The present disclosure further relates to a radar system and to a motor vehicle.

### SUMMARY

A need exists to provide an improved process for determining target information of radar targets.

The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic view of a reception signal of a conventional radar system of the state of the art;

FIG. 2 shows an example schematic transmitter-receiver structure of a radar system;

FIG. 3 shows as an example how to calculate a range Doppler of constantly moving target;

FIG. 4 shows an example receiving data structure;

FIG. 5 shows an example schematic motor vehicle, which comprises the radar system of FIG. 2;

FIG. 6 shows an example of a signal transmission based on a Multiple-Input-Multiple-Output-(MIMO)-method;

FIG. 7 shows as an example a phase propagation along the chirp sequences for receiving antennas;

FIG. 8 shows for example a field of view of one of the transmitting antennas, wherein a pseudo target is considered;

FIG. 9 shows according to FIG. 8 an example data structure as a possible result;

FIG. 10 shows as an example according to FIG. 8 the field of view, but here another pseudo target is considered;

FIG. 11 shows according to FIG. 10 other example data structures;

FIG. 12 shows as an example according to FIG. 8 the field of view, but here another pseudo target is considered;

FIG. 13 shows according to FIG. 12 other example data structures;

FIG. 14 shows as an example according to FIG. 8 the field of view, but here another pseudo target is considered;

FIG. 15 shows according to FIG. 14 other example data structures;

FIG. 16 shows as an example according to FIG. 8 the field of view, but here another pseudo target is considered;

FIG. 17 shows according to FIG. 16 other example data structures;

FIG. 18 shows example different data structures, where in for each data structure an individual range-Doppler-map is generated;

FIG. 19 shows a non-fitting target hypothesis where a range-Doppler hypothesis of −60° is provided for example;

FIG. 20 shows according to FIG. 19 different example phase corrected Doppler signals of different receiving antennas by a hypothesis of −60°;

FIG. 21 shows in contrast to FIG. 19 an example fitting target hypothesis where a range-Doppler hypothesis of −22.3404° is provided for example;

FIG. 22 shows according to FIG. 21 different example phase corrected Doppler signals of different receiving antennas by a hypothesis of −22.3404°;

FIG. 23 shows that example starting phases of each example receiving process may be coherent and equal. Especially the after the starting phases following phases are equal;

FIG. 24 shows an example range matrix;

FIG. 25 shows as an example a number of different range matrices of individual MIMO sequences;

FIG. 26 shows an example schematic field of view an antenna, where a hypothesis model p_{H} may be used to estimate an angle.

FIG. 27 shows an example construction of an aperture hypothesis according to FIG. 25;

FIG. 28 shows an expended hypothesis model;

FIG. 29 shows as an example an aperture hypothesis based on the expended hypothesis model of FIG. 28;

FIG. 30 shows an example control flow how to estimated angle in azimuth and elevation;

FIG. 31 shows schematically an example definition of compressed sensing for angel estimation; and

FIG. 32 shows schematically am example process flow how to the calculation of a direction of arrival may be done.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

According to some embodiments, a method for determining at least one target information of at least one radar target of a radar system is provided, wherein the radar system comprising at least one antenna array, which comprising multiple transmitting antennas and multiple receiving antennas, wherein each transmitting antenna of the multiple transmitting antennas transmits a radar signal into an environment of the radar system in successive transmission operation.

In some embodiments and after each transmitting operation, at least some of the plurality of receiving antennas receive reflected received signals from the radar target in the environment based on the transmitted radar signal of the respective transmitting operation, wherein multiple hypothesis of target angles with regards to the radar target are specified, and for each hypothesis of a target angle a data structure is generated based on the received signals, wherein each data structure comprised the received signals which correspond to the hypothesis of the target of the respective data structure. For each generated data structure an individual range-Doppler-map is generated based on the individual received signals of each data structure, and the target information of the radar target is determined based on the range-Doppler-maps of the date structures.

The proposed method has the benefit that a process for determining target information of radar targets of a radar system or other sensor systems may be improved. Another benefit of the proposed method is, that signal-to-noise-ratio (SNR) in the range-Doppler-maps or range-Doppler-matrices may increase. Through this, the signal-to-noise-ration of the radar system may further increase. The determining of target information of radar target may be improved.

SNR is a parameter that affects the performance and quality of systems that process or transmit signals, such as communication systems, audio systems, radar systems, imaging systems, and data acquisition systems. A high SNR means that the signal is clear and easy to detect or interpret, while a low SNR means that the signal is corrupted or obscured by noise and may be difficult to distinguish or recover. SNR may be improved by various methods, such as increasing the signal strength, reducing the noise level, filtering out unwanted noise, or using error correction techniques.

Due to the sparse, non-uniform and large geometry of the antenna array, conventional signal processing algorithms may fail to compensate phase shifts and do not result in an unambiguous angular measurement. Therefore the proposed method may be used to solve or reduce these problems.

The proposed method has further a benefit in that the signal processing time and/or the signal processing procedure of determining target information of at least one radar target of a radar system increases.

In particular, the signal processing may be done coherent in some embodiments. This is beneficially for distributed antennas of a radar system.

The proposed method may in some embodiments be used to improve the environmental detection of vehicles. When using a radar system in the automotive sector, for example, accurate, improved and yet simpler detection of objects is beneficial. Here, increased detection performance and reduced side lobe ambiguity in conjunction with a high angular resolution of the radar system may be important, for example, for lane guidance, for carrying out an overtaking manoeuvre, or for obstacle detection.

In some embodiments, the proposed method may be used to modify a radar system in this way, so that for the radar system a high angular resolution like at a lidar system is available. Another benefit of the proposed method is to reduce the number of transmitting antennas and receiving antennas of the radar system.

In some embodiments, a coherent processing of data of distributed apertures, radar networks, monostatic antennas, bistatic antennas, non-uniform antennas, sparse antennas, non-equidistant antenna spacing and with curved spatial dimension in 2D or 3D, especially in dynamic applications, such as automobiles, trains, airplanes and ships is possible.

In some embodiments, the proposed method may solve a problem that large antenna arrays exhibit due to the geometrical antenna placement, namely a paralaxis effect which results in ambiguous range with respect to the path sending antenna—target—receiving antenna.

Due to the sparse, non-uniform and large geometry of the antenna array, conventional signal processing algorithms fail to compensate phase shifts and do not result in an unambiguous angular measurement. Therefore, the proposed method may be used to solve this problem.

In some embodiments, a coherent signal processing chain for the distributed radar antenna may be provided.

The radar system may in some embodiments comprise one antenna array or several antenna arrays. The transmitting antennas may be understood as transmitter to send out radar signals in the environment. The receiving antennas may be understood as receiver to receive signals, which are reflected on an object, especially a target, in the environment.

In some embodiments, the multiple transmitting antennas and the multiple receiving antennas may be distributed arranged on the antenna array.

An antenna array, which may also be referred to as an aperture or antenna aperture or array aperture, may in some embodiments be a surface or a predefined area on which or within which several or a large number of individual antennas or antenna elements are arranged. For example, an antenna array may be used to both transmit and receive signals.

At least one transmit signal or several transmit signals may be emitted in the environment of the radar system in some embodiments. If at least one of these transmitted signals, such as the at least one transmitted signal, hits a radar target, such as an object in the vicinity, this signal is reflected accordingly and reflected back in the direction of the radar system. Therefore, every transmitting antenna of the several transmitting antenna transmit an individual radar signal in successive transmission operation. In other words, in each transmission operation only one transmitting antenna is sending out a radar signal. After each transmission operation or transmission round the receiving antennas receives the reflected received signals.

In other words, a variation of transmitting antennas in successive MIMO cycles is applied in some embodiments. In each MIMO cycle one transmitting antenna is transmitting a radar signal.

The data structures may be generated by an electronic evaluation circuit or unit of the radar system in some embodiments. On the basis of the received signals, the data structures, especially data packages, are generated by the evaluation circuit. The evaluation circuit may further be configured to perform different signal processing process of the radar system.

In some embodiments, all received signals of all transmission operations are sorted by the respected transmitting antenna. In other words, all received signals, which are based on the same transmitting antenna, may be selected to the data structure of the respected transmitting antenna.

In some embodiments, the evaluation circuit may estimate the range-Doppler-map or a range-Doppler-spectrum or a range-Doppler-matrix for each data structure.

For example, a large number of different hypothesis of target angles with regards to the radar target are specified or are estimated.

The data structure may be designated as hypothesis data structures or hypothesis databases.

In some embodiments, for each hypothesis of a possible target angle, an individual data structure is generated based on the received signals, wherein each data structure comprised the received signals which correspond to the hypothesis of the target of the respective data structure. Furthermore, for each generated data structure, an individual range-Doppler-map is generated based on the individual received signals of each data structure. Especially, a range-Doppler-map shows how far away the targets are and how quickly they are approaching or receding.

After this, the target information of the radar target is determined based on the range-Doppler-maps of the date structures in some embodiments.

In some embodiments, for each transmission operation one of the plurality of the transmitting antennas which, in particular only, transmits a radar signal is defined in any order, in particular the one of the plurality of the transmitting antennas which, in particular only, transmits a radar signal in each transmission operation is randomized default. Through this, the determining of the target information of the radar target may be carried out more efficient and/or faster. In other words, the transmitting antenna of each transmission operation which only transmit a radar signal may be defined randomly.

A target range and/or a target speed of the radar target may be estimated based on the target detection in some embodiments.

In some embodiments, multiple pseudo targets are determined based of a respective field of view of each transmitting antenna. Each transmitting antenna contains an individual field of view, in which possible radar targets may be detected. According to the field of view of a respective transmitting antenna suitable for this hypothesis, target angels may be specified or estimated. With respect to the pseudo targets, the data structures may be generated easier.

The pseudo targets may be possible targets, which possibly may be detected with a transmitting antenna. In other words, the pseudo targets are not real targets but instead theoretical targets.

In some embodiments, for each pseudo target a range bin is determined based on the radar signal of the respective transmitting antenna and on a received signal which correspond to the radar signal. A transmitting antenna sends at least one radar signal and at least one to this corresponding received signal may be received. According to the pseudo targets based of the field of view of the transmitting antenna for each of these pseudo targets a range bin may be estimated in some embodiments. In other words, for each pseudo target a two way path distance may be estimated.

In some embodiments, hypothesis of the directions of arrival of the radar target are determined on the basis of the range bin of the pseudo targets, wherein the multiple hypothesis of target angles are specified based on the hypothesis of the directions of arrival.

According to the possible pseudo target, the real radar target may be analysed. Therefore, one or more hypothesis of the direction on arrival may be considered. Based on this, the target information may be estimated. Therefore, the hypothesis of target angles may be considered.

In some embodiments, a construction of an aperture hypothesis for each pseudo target is applied based on the respective pseudo target. In some embodiments, the pseudo targets may be expanded in their information content. This is helpful at determining of the hypothesis of the directions of arrival of the radar target.

In some embodiments, a target detection of the radar target is applied based on a range-Doppler-map of each data structure. Through this, on the basis of each range-Doppler-map, the presence of the radar target or other object in the environment may be checked. It may be tried, based on each data structure, to detect the radar target. Therefore, more information of the radar target may be generated and the determining of the target information of the radar target may be more efficient.

A target range and/or a target speed of the radar target may be estimated based on the target detection in some embodiments.

In some embodiments, the received signals of each data structure are coherent combined for determining the range-Doppler-map of each data structure. Therefore, the less antennas of an antenna array are needed and the processing time may be increased faster. By combining the received signals coherently, the individual antennas of the antenna array may be arranged in any order.

In some embodiments, for each range-Doppler-map of the data structures an individual target signal relating to the radar target is generated based on each range-Doppler-map. In other words, a local aperture signal, also called “snapshot”, is indexed by each range-Doppler-map, also called range-Doppler-cell. The target signals may be used for angel estimation of the radar target.

In some embodiments, for each range-Doppler-map a Doppler compensation is applied based on a Doppler compensation filter which is based on the individual target signal. Based on the Doppler compensation filter each target signal may be compensated. The Doppler compensation filter may be generated for each data structure individuality.

In some embodiments, the target information of the radar target is determined based on an orthogonal matching pursuit algorithm or a compressive sensing algorithm. Thus, with the help of the range-Doppler-maps, an approximation algorithm, in particular a sparse approximation algorithm, may be used to determine the corresponding target information or several target information. Therefore, an accurate angle target information may be estimated.

In some embodiments, the compensated target signals or compensated local aperture signals may be used as input for the orthogonal matching pursuit algorithm or a compressive sensing algorithm.

In some embodiments, with the target information, an angle and/or a direction to the radar target is provided. In other words, the target information may be used in particular to estimate an angle in order to be able to determine a corresponding angle with respect to the radar target relative to the radar system and/or a direction of the radar target. This is particularly relevant for detecting the surroundings of a vehicle.

According to some embodiments, a Radar system is provided. The radar system comprising at least one antenna array, which comprised multiple transmitting antennas and multiple receiving antennas, and an electronic evaluation circuit, wherein the radar system is designed to carry out a method according to the teachings herein. In particular, the method described above may be carried out with the radar system just mentioned.

The radar system is, for example, an electronic radar device or radar device with which radar targets in an environment may be detected or recorded. In particular, the radar system may have several antenna arrays, which in turn may be referred to as an antenna array. Thus, the radar system may have a plurality of antenna arrays arranged in a distributed manner, which in turn may each have several transmitting elements and receiving elements. In this way, the proposed radar system may be used to detect a surrounding area, in particular 360 degrees.

The electronic evaluation circuit may be an electronic computing system and/or comprise one or more processors. In particular, the electronic evaluation circuit may be designed as a distributed system, whereby at least part of the evaluation circuit may be arranged in a respective antenna array in order to carry out corresponding pre-processing. The electronic evaluation circuit may also be designed as a central system, which is linked or coupled to the respective antenna arrays in terms of communication or data technology in order to be able to carry out a corresponding evaluation of the target information.

According to some embodiments, a motor vehicle which comprising a radar system according to the teachings herein is provided.

For example, the aforementioned radar system may be integrated or installed in the aforementioned vehicle. This means that the aforementioned radar system may be used to detect the vehicle's surroundings. This may be used in particular for driver assistance systems or autonomous systems of the vehicle.

In some embodiments, the transmitted antennas and the receiving antennas of the antenna array are arranged at a distance from each other on the motor vehicle.

In particular, the antennas of the antenna array of the radar system are arranged at a distance from one another, so that a large area may be covered accordingly with the aid of fewer antenna array. With the method according to the teachings herein, radar information may in turn be effectively determined even if the antenna array of the radar system have uneven, difficult and/or non-equidistant antenna spacings from one another. This is particularly beneficial for the use of the radar system in the automotive sector, since antenna arrays may thus be arranged in a wide variety of areas or positions in and/or on the motor vehicle in order to be able to perform, in particular, 360-degree detection of the area surrounding the motor vehicle.

According to some embodiments, a method for determining at least one target information of at least one radar target of a radar system is provided, wherein the radar system comprising at least one antenna array, which comprising multiple transmitting antennas and multiple receiving antennas is provided. Here may be done an incoherent signal processing according to the following. Each transmitting antenna of the multiple transmitting antennas transmits a radar signal into an environment of the radar system in successive transmission operation. After each transmitting operation, at least some of the plurality of receiving antennas receive reflected received signals from the radar target in the environment based on the transmitted radar signal of the respective transmitting operation. The received signals are sorted on the basis of the transmitting antennas on which the individual received signals are based, and for each transmitting antenna a data structure is generated based on the sorted received signals, wherein each data structure comprised the received signals which based on the transmitting antenna on which the individual data structure is generated, wherein for each generated data structure an individual range-Doppler-map is generated based on the individual received signals of each data structure. The range-Doppler-maps of the date structures are averaged, and the target information of the radar target is determined based of the averaged range-Doppler-map of the date structures.

Embodiments of one aspect (e.g., method, system, vehicle) may be regarded as embodiments of the other aspects or of all aspects. This applies vice versa.

For example, the radar system and/or the motor vehicle has (technical) means for carrying out or being able to carry out the method according to the teachings herein.

The disclosure also comprises further embodiments of the radar system and of the motor vehicle, which have features as already described in connection with the further embodiments of the method according to the teachings herein. For this reason, the corresponding further embodiments of the radar system and of the motor vehicle are not described again herein.

The invention also comprises combinations of the (different) embodiments described.

Reference will now be made to the drawings in which the various elements of embodiments will be given numerical designations and in which further embodiments will be discussed.

In the embodiments described herein, the described components of the embodiments each represent individual features that are to be considered independent of one another, in the combination as shown or described, and in combinations other than shown or described. In addition, the described embodiments can also be supplemented by features other than those described.

Specific references to components, process steps, and other elements are not intended to be limiting. Further, it is understood that like parts bear the same or similar reference numerals when referring to alternate FIGS. The FIGS. are schematic and not necessarily to scale.

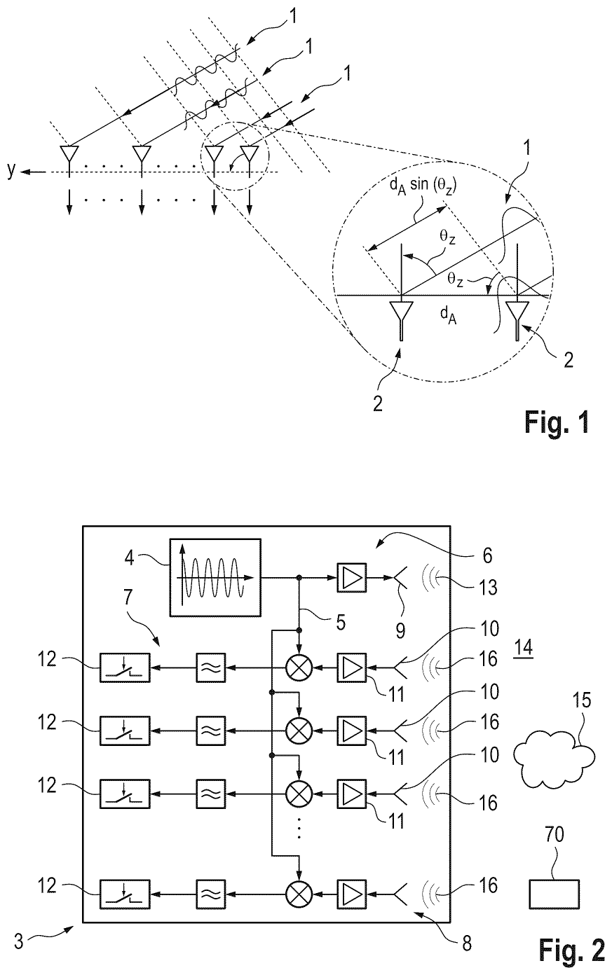

FIG. 1 shows a schematic view of a reception signal 1 of a conventional radar system of the state of the art. This radar system comprises at least one or more uniform linear antennas 2. There may be a spatial antenna distance d_{A} between two uniform linear antennas 2. There may be an incidence angel θ_{z} at each of the uniform linear antennas 2. Especially an angle estimation may be bone based on the above described information. Therefor an angel depended phasor may be calculated with the following equation,

$${s}_{B} ( {n}_{c} , {l}_{c} , m ) \approx exp ( - j 2 π \frac{{d}_{A}}{λ} sin ( {θ}_{z} ) m )$$

wherein m shows an antenna index, n_{c} an constant sample index and l_{c} a constant chirp index.

FIG. 2 shows a schematic transmitter-receiver structure of a radar system 3. An optical signal 5 may be generate with a waveform generator 4. This optical signal 5 may be send by optical wires to a transmitter 6 and/or to at least one receiver 7.

The radar system may contains an electronic evaluation circuit 70 to process information and/or data. The electronic evaluation circuit 70 may be formed as an electronic evaluation device or as an electronic evaluation system or as a computing device.

The transmitter 6 and the at least one receiver 7 may be part of an antenna array 8 of the radar system 2. The antenna array 8 may be comprise multiple transmitting antennas 9, which may be arranged on the transmitter 7. The antenna array 8 may be comprise also multiple receiving antennas 10, which may be arranged on the at least one receiver 7. The receiver 7 or all of these receivers may be comprise a low noise amplifier 11 and an inphase channel 12 for signal processing.

For example each transmitting antenna of the multiple transmitting antennas 9 may transmit a radar signal 13 into an environment 14 of the radar system 3 in successive transmission operation. After each transmitting operation, at least some of the plurality of receiving antennas 10 may receive reflected received signals 16 from a radar target 15 in the environment 14 based on the transmitted radar signal 13 of the respective transmitting operation.

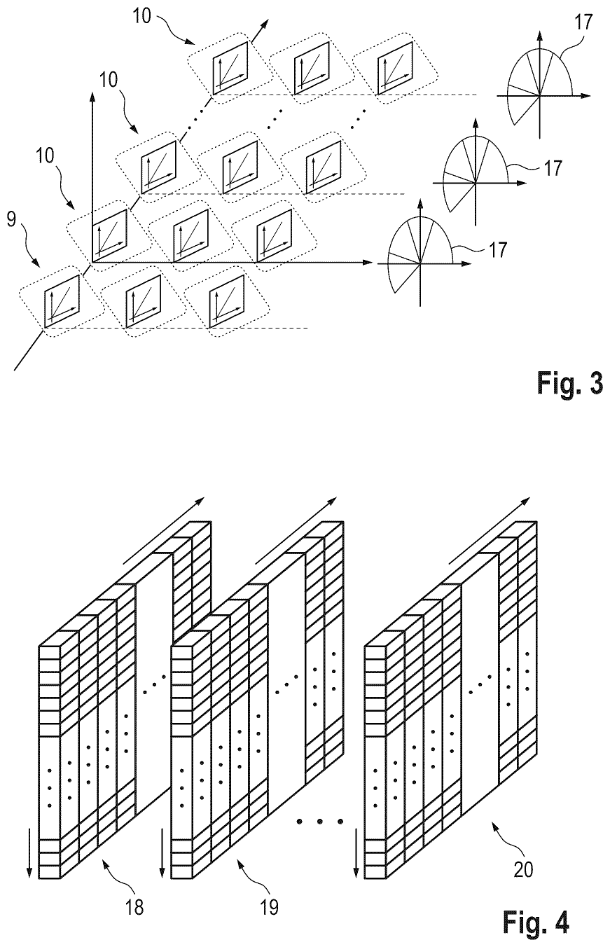

FIG. 3 shows as an example how to calculate a range Doppler of constantly moving target. This moving target may be moves towards an antenna boresight direction. The calculation may be done in a far field model.

Here may be transmit radar signals 13 in different transmission operations with the transmitting antennas 9. In this example, a constant phase shift with each new transmitted pulse or radar signal 13 is present. After each transmission operation the phase shift 17 is constant.

FIG. 4 shows an example receiving data structure. A linear phase progression for a moving target along a pulse sequence may be done. For each receiving antenna 10 an own data structure 18, 19, 20 may be generated. The benefit of this is that each receiving antenna 10 allows the calculation of its own range-Doppler-matrix. As an example, a constantly moving target in the same range gate shows a coherent linear phase progression between all receiving antennas 10.

Therefore, a constant range signal may be calculated with the following equation:

$${S}_{B} ( {u}_{c} , m , k ) = {S}_{B} ( {u}_{c} , k ) \times exp ( j 2 π {f}_{D} {mT}_{chirp} )$$

Particularly, a Doppler depended phase may be calculated with the following equation:

$$φ ( {S}_{B} ( {u}_{c} , m , K ) ) = mx \qquad x = 2 π {f}_{D} {T}_{chirp}$$

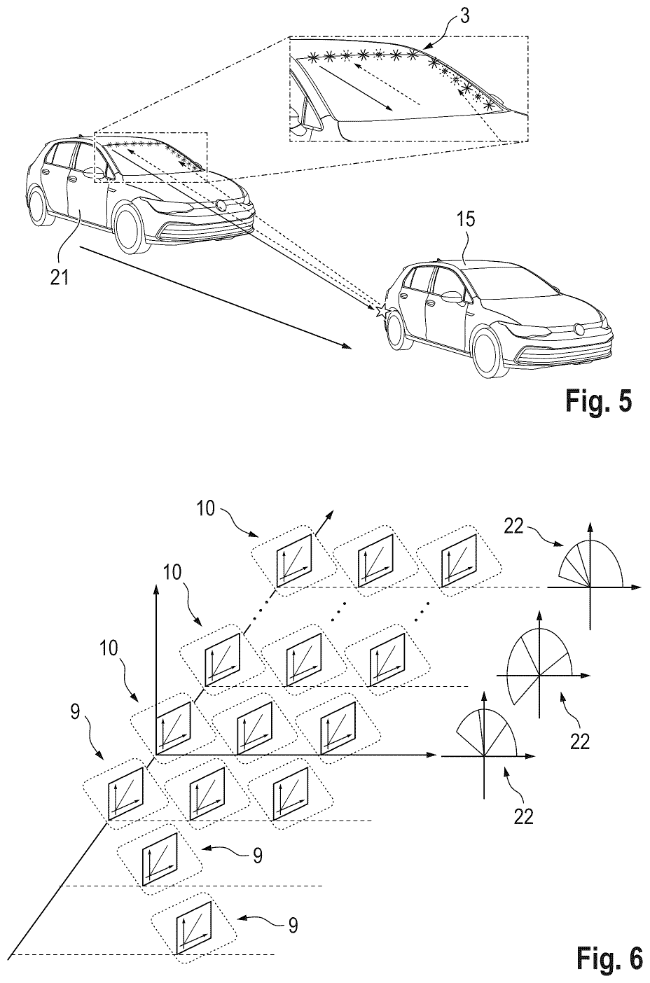

FIG. 5 shows a schematic vehicle 21, which comprises especially the radar system 3. In front of the motor vehicle 21 another vehicle, like the radar target 15 is moving.

Particularly, the transmitted antennas 9 and the receiving antennas 10 of an antenna array may be arranged at a distance from each other on the motor vehicle 21.

Particularly, a signal model for a radar antenna in a large array may be calculated with the following equation:

$$s ( n , m , k , l ) = \text{?} {\underbrace{exp ( 2 π j \frac{B}{{T}_{chirp} {c}_{0}} ( 2 \text{?} {T}_{RRI} m + \text{?} ( k , l ) {nT}_{s} ) )}}_{Range Doppler Coupling} \times \text{?}$$

$$\text{?} \text{indicates text missing or illegible when filed}$$

Wherein n shows a sample index, m shows a chirp or pulse index, k shows a receiving antenna index and l shows a transmission antenna index. Furthermore shows the parameter i a target index, dₜ(k,l) a two way target distance and T_{RRI} a ramp-repetition-interval.

FIG. 6 shows an example of a signal transmission based on a Multiple-Input-Multiple-Output-(MIMO)-method. At this each transmitting antenna of the multiple transmitting antennas 9 transmits a radar signal 13 into the environment 14 of the radar system 3 in successive transmission operation. After each transmitting operation, at least some of the plurality of receiving antennas 10 receive reflected received signals 16 from the radar target 15 in the environment 14 based on the transmitted radar signal 13 of the respective transmitting operation.

Especially for each transmission operation the one of the plurality of the transmitting antennas 9 which transmits a radar signal 13 may be defined in any order, in particular the one of the plurality of the transmitting antennas 9 which transmits a radar signal 13 in each transmission operation is randomized default. The received signals 16 which may be received after each transmission operation may be mixed with the radar signal 13 of the transmitting antenna 9 of the individual transmission operation.

It is assumed here that a target is constantly moving. This moving target may be moves towards an antenna boresight direction. The calculation may be done in a far field model. The pulse sequence may be radiated from different transmitting antennas.

However, this is where a problem lies, that spatial distance of varying transmitters causes different distance dependent phase shifts 22. The consequence of this is that a coherent integration of individual range-Doppler-matrices is not possible.

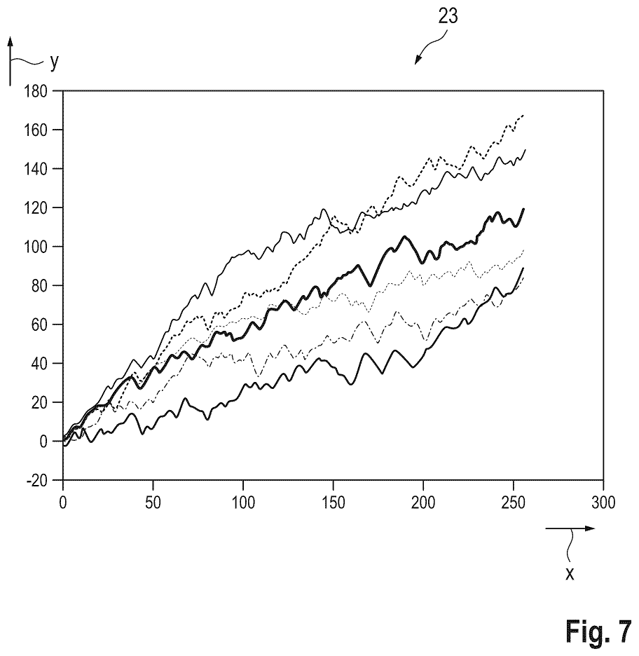

FIG. 7 shows by way of example a phase propagation along the chirp sequences 23 for all or a defined number of receiving antennas 10. The x axis shows a sample index in n and the y axis shows a phase in rad. It would be beneficial here to change phase term due to varying transmitting and/or receiving antenna paths. Therefor the proposed teachings herein may be provided.

Due to the sparse, non-uniform and large geometry of the antenna array, conventional signal processing algorithms fail to compensate phase shifts and do not result in an unambiguous angular measurement. Therefore, novel approaches are needed. This is where the present teachings herein is beneficially used.

Maybe a two-step approach may be done. First a sensing matrix for direction of arrival may be estimate. This is useful for a Doppler calculation. And second a Doppler compensation of identified target may be done.

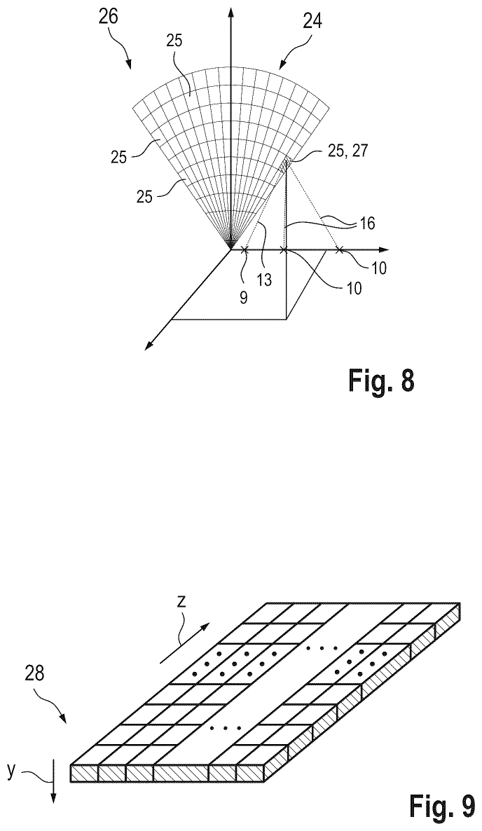

FIG. 8 shows for example a field of view 24 of one of the transmitting antennas 9. Maybe each transmitting antenna 9 has an individual field of view.

An antenna may be able to detect object's which are within the field of view of this antenna.

For example multiple pseudo targets 25 may be determined based of the respective field of view 24. According to this a hypothesis model 26 may be estimated, which may be use to estimate an angle in azimuth and elevation of radar targets.

Therefor a hypothesis model P_{H} may be provided for one pseudo target 27 of the multiple pseudo targets 25.

The hypothesis model p_{H} may be calculated as following:

$${\vec{p}}_{H} = {r}_{H} ( \begin{matrix}cos {θ}_{H} \\ sin {θ}_{H} \\ 0\end{matrix} )$$

Here r_{H} may be constant and θ_{H} may be −60°.

FIG. 9 shows according to FIG. 8 as an example a data structure 28 or a hypothesis data structure.

On the z axis is applied the pulses in correlation of transmitting antennas. On the y axis is applied the range gates.

For each hypothesis of a target angle the data structure 28 may be generated based on the received signals 16, wherein the data structure 28 comprised the received signals 16 which correspond to the hypothesis of the target angle of this respective data structure 28.

The example data structure 28 may be here provided for a direction of arrival of 0°.

For the pseudo target 27 may be determined a range bin based on the radar signal 13 of the respective transmitting antenna 9 and on at least the received signal 16 which correspond to the radar signal 13.

With the following equation the range bin, also called as pseudo target two way path distance, may be calculated.

$$d ( k , l ) = {‖ \text{?} - {\vec{p}}_{H} ‖}_{2} + {‖ \text{?} - {\vec{p}}_{H} ‖}_{2}$$

$$\text{?} \text{indicates text missing or illegible when filed}$$

Furthermore a direction of arrival hypothesis may be estimate with the following equation:

$$s ( k , l ) = exp ( - \frac{2 π}{λ} jd ( k , l ) )$$

Furthermore one or more hypothesis of the directions of arrival of the radar target, in particular the pseudo target 27, may be determined on the basis of the range bin of the pseudo target 27, wherein the multiple hypothesis of target angels are specified based on the hypothesis of the directions of arrival.

Especially multiple hypothesis of target angles with regards to the radar target may be specified.

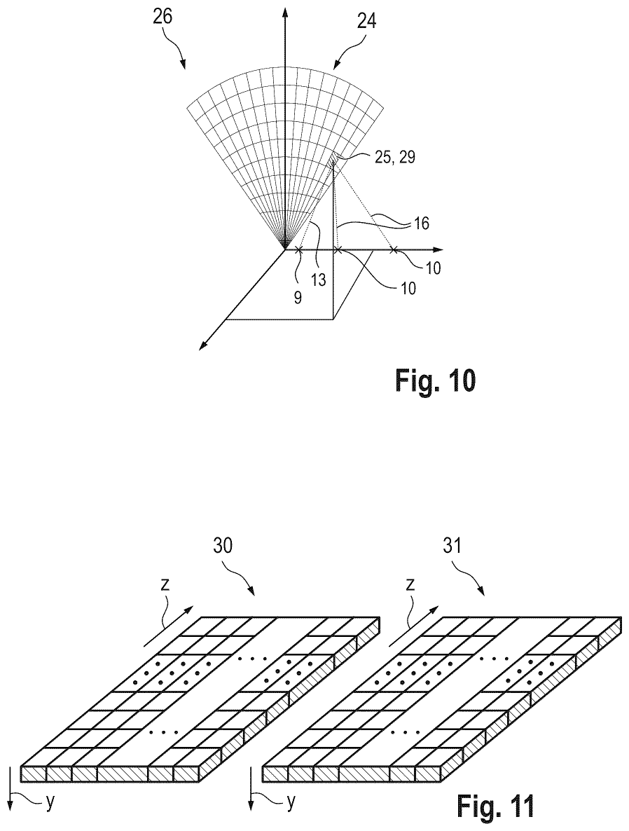

In FIG. 10 shows for example according to FIG. 8 the field of view 24, but here is another pseudo target 29 considered. The comments on FIG. 8 apply analogously here.

In FIG. 11 are according to FIG. 9 two data structures 30, 31 shown. The data structure 30 may be here provided for a direction of arrival of 0°. The data structure 31 may be here provided for a direction of arrival of 1°. The comments on FIG. 9 apply analogously here.

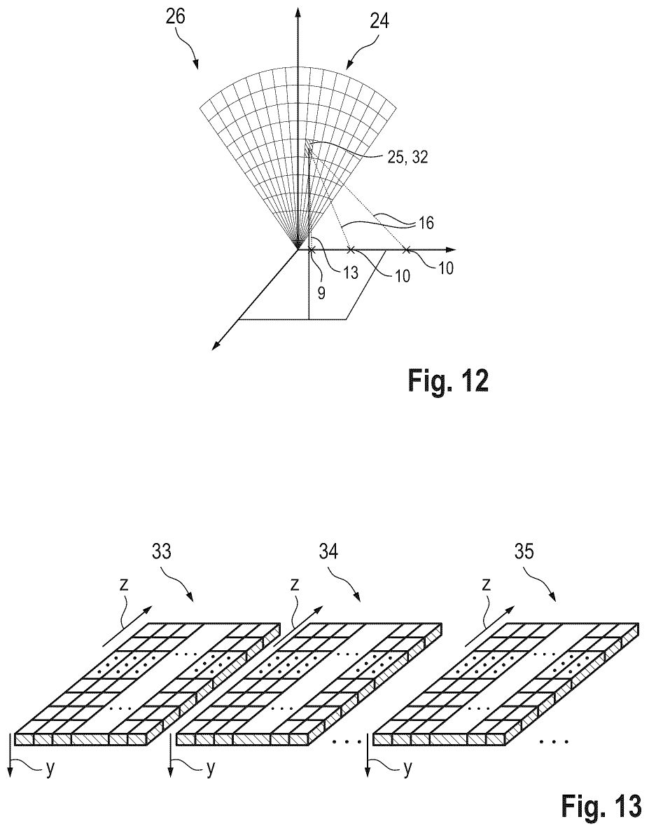

FIG. 12 shows another example pseudo target 32 within the field of view 24. Based on this pseudo target 32 for different directions of arrival different data structures 33, 34, 35 (see FIG. 13) may be determined. The data structure 33 may be here provided for a direction of arrival of 0°. The data structure 34 may be provided for a direction of arrival of 1°. The data structure 34 may be here provided for a direction of arrival of 15°. Particularly for any directions of arrival an individually data structure may be provided. The comments on FIG. 9 apply analogously here.

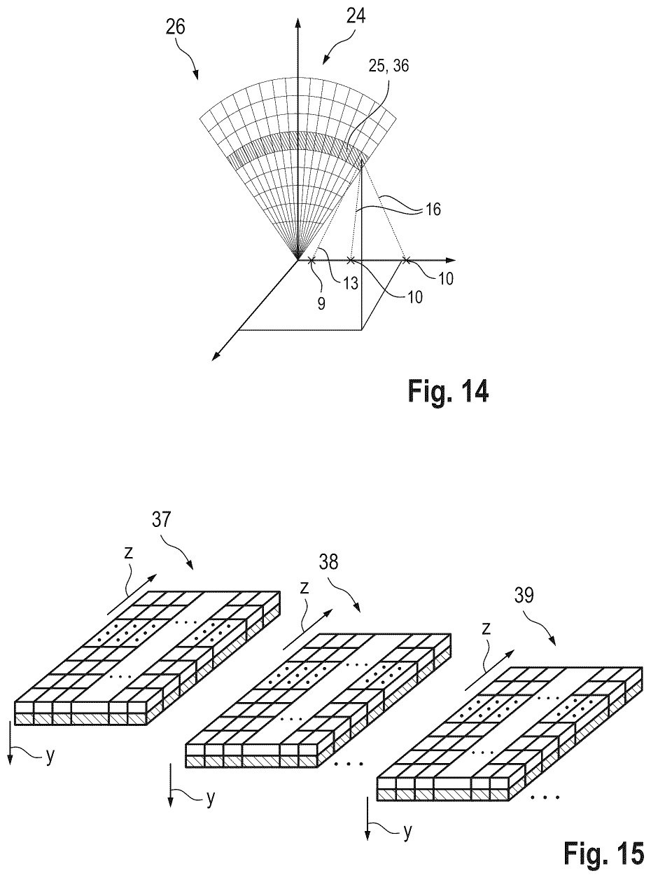

FIG. 14 shows another example pseudo target 36 within the field of view 24. Here the pseudo target 36 may be a wider expansion. Based on this pseudo target 36 for different directions of arrival different data structures 37, 38, 39 (see FIG. 15) may be determined. The data structure 37 may be here provided for a direction of arrival of 0°. The data structure 38 may be provided for a direction of arrival of 1°. The data structure 39 may be here provided for a direction of arrival of 15°. The data structures 37, 38, 39 here have more levels in y axis as at the previous figures. Particularly for any directions of arrival an individually data structure may be provided. The comments on FIG. 9 apply analogously here.

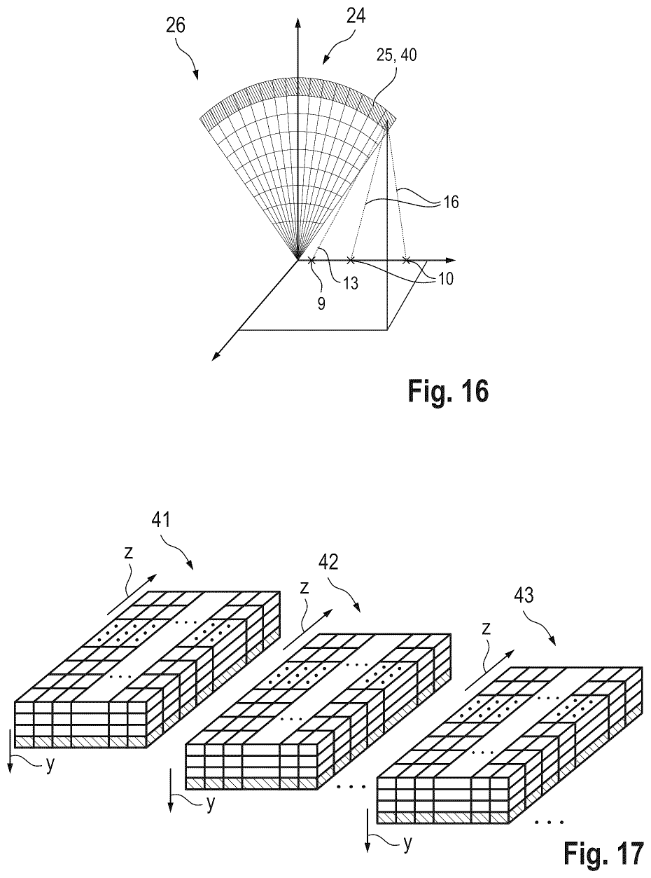

FIG. 16 shows another example pseudo target 40 within the field of view 24. Here the pseudo target 40 may be a wider expansion. Based on this pseudo target 40 for different directions of arrival different data structures 41, 42, 43 (see FIG. 17) may be determined. The data structure 41 may be here provided for a direction of arrival of 0°. The data structure 42 may be provided for a direction of arrival of 1°. The data structure 43 may be here provided for a direction of arrival of 15°. The data structures 41, 42, 43 here have different levels in y axis. This means that for different range gate or range bins data be collected. Particularly for any directions of arrival an individually data structure may be provided. The comments on FIG. 9 apply analogously here.

As shown in the previous FIGS. for example that for each hypothesis of a target angle, in particular a direction of arrival, a data structure may be generated based on the received signals 16, wherein each data structure comprised the received signals 16 which correspond to the hypothesis of the target of the respective data structure.

With the help of the data structure, targets may be determined for the assumption that the target is located in the respective direction of arrival.

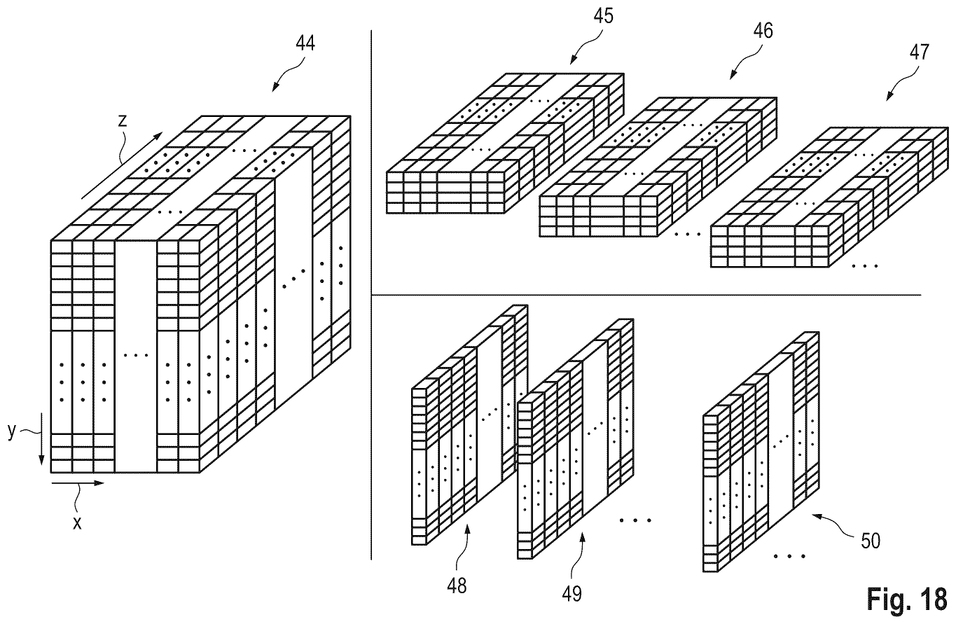

FIG. 18 shows for example a range matrix 44.

Here is on the x axis of the range matrix 44 the receiving antenna index applied. On the y axis of the range matrix 44 the sample index is applied. And on the z axis of the range matrix 44 the pulse per transmitting antenna is applied.

Furthermore are here by way of example shown different data structure 45, 46, 47 which may be provided as in the previous FIGS.

For each generated data structure 45, 46, 47 an individual range-Doppler-map 48, 49, 50 is generated based on the individual received signals 16 and/or the individual direction of arrival of each data structure 45, 46, 47. A target information of the radar target 15 may be determined based on the range-Doppler-maps 48, 49, 50 of the date structures 45, 46, 47.

Hereby may select those date of a date structure 45, 46, 47, which show a maximum respect to the individual direction of arrival.

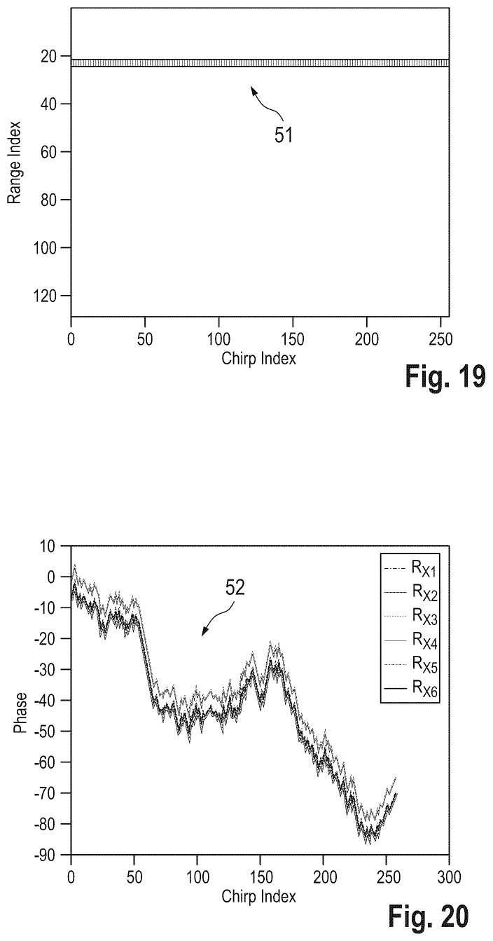

FIG. 19 shows a non-fitting target hypothesis. Here a range-Doppler hypothesis 51 of −60° is provided for example. According to these FIG. 20 shows different phase corrected Doppler signals 52 of different receiving antennas by a hypothesis of −60°.

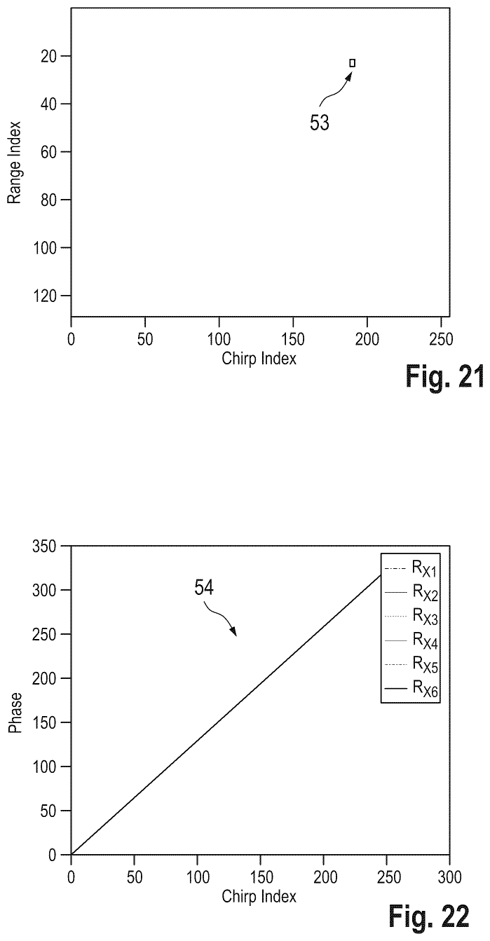

FIG. 21 shows in contrast to FIG. 19 a fitting target hypothesis. Here a range-Doppler hypothesis 53 of −22.3404° is provided for example. According to these FIG. 22 shows different phase corrected Doppler signals 54 of different receiving antennas by a hypothesis of −22.3404°. This may be achieved by the above teachings herein.

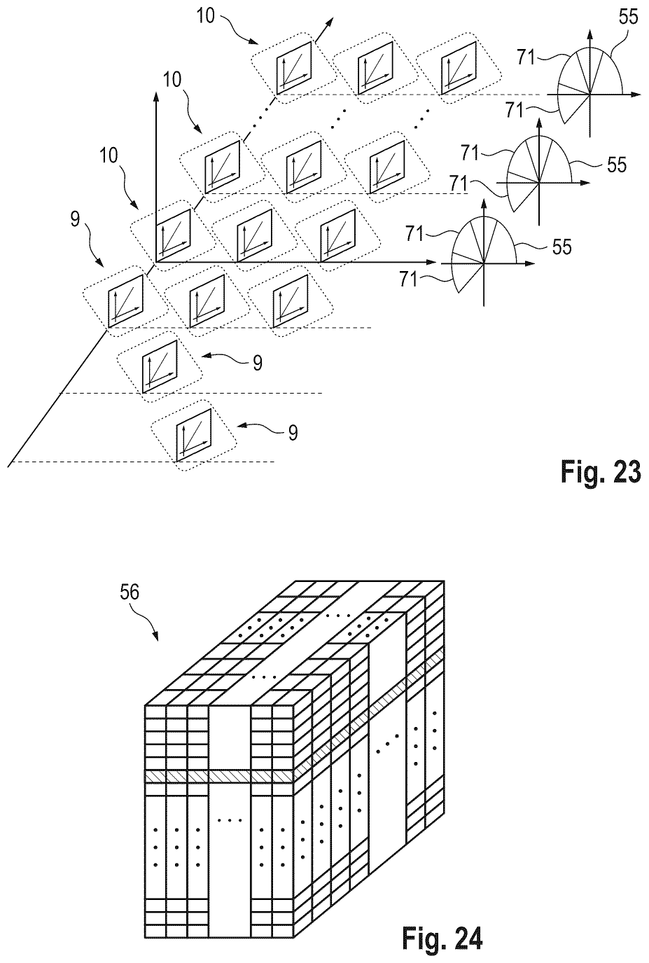

FIG. 23 shows an example result of the previous embodiments. The starting phases 55 of each receiving process may be coherent and so equal. Especially the after the starting phases 55 following phases are equal. This means that a coherent signal processing may be done.

In particular a range-Doppler-spectrum with the preceding signal processing contains a signal-to-noise ratio, which could be improved.

In the following FIGS. a brief description how to estimate an angular is shown.

FIG. 24 shows an example range matrix 56, which may be a data structure 45, 46, 47. Based on the range matrix 56 may be estimate a target signal of a radar target. Particularly this target signal may be calculated with the following equation:

$$\text{?} ( {u}_{c} , m , k , l ) = S ( {u}_{c} ) {\underbrace{exp ( \frac{2 π}{λ} j 2 {v}_{t} {T}_{RRI} m )}}_{Doppler dependent phase} {\underbrace{exp ( \frac{2 π}{λ} {jd}_{t} ( k , l ) )}}_{DoA dependent phase}$$

$$\text{?} \text{indicates text missing or illegible when filed}$$

This equation contains a Doppler dependent phase and a direction of arrival (DoA) dependent phase.

In signal processing, direction of arrival denotes the direction from which usually a propagating wave arrives at a point, where usually a set of sensors are located.

Particularly for each range-Doppler-map or the range matrix 56 a Doppler compensation may be applied based on a Doppler compensation filter which is based on individual target signal. Particularly this filter may be described with the following equation:

$${S}_{DP} ( m , o ) = exp ( - \frac{2 π}{λ} j 2 {v}_{t} ( o ) {T}_{RRI} m )$$

The relationship chirp index Doppler velocity may be calculated with the following equation:

$${v}_{t} ( o ) = \frac{{c}_{0}}{2 {f}_{0}} \frac{o}{{LT}_{RRI}}$$

Based on the Doppler compensation filter a Doppler compensation of the target signal may be done. This may be described with the following equation:

$$S ( k , l ) = S ( {u}_{c} , m , k , l ) {S}_{DP} ( m , o )$$

Finally a aperture snapshot may be calculated with the following equation:

$$S ( k , l ) = S ( {u}_{c} ) exp ( \frac{2 π}{λ} {jd}_{t} ( k , l ) )$$

With an optionally derivation of the aperture snapshot may be estimated an angular.

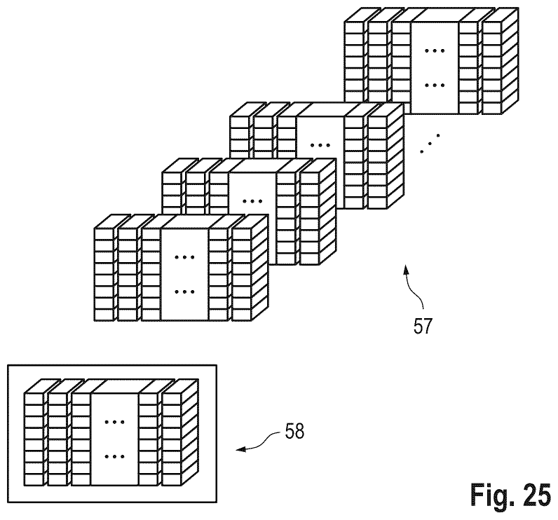

FIG. 25 shows for example a number of different range matrices 57 of individual MIMO sequences.

Here a redistribution of the range gate with the expected target angle may be put into a target data structure according to the array manifest of virtual antenna elements. Maybe a transfer of the identified range gates from each chirp and/or into each transmitter-receiver combination.

A rang Doppler matrix 58 may be estimated based on the aperture snapshot adjusted by Doppler phase term.

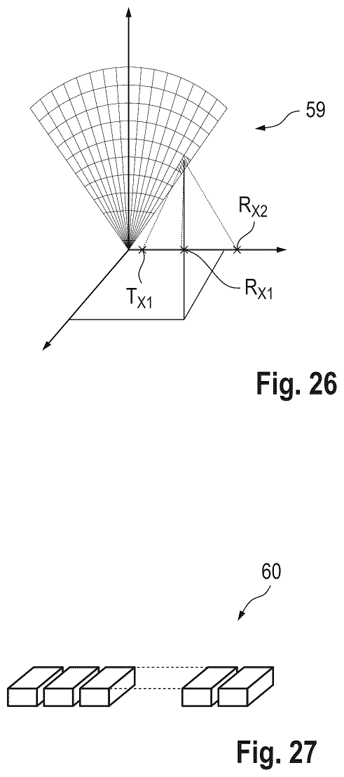

FIG. 26 shows a schematic field of view 59 of an antenna. Therefor a hypothesis model P_{H} may be used to estimate an angle.

The hypothesis model p_{H} may be calculated as following:

$$\text{?} = {r}_{H} ( \begin{matrix}cos {θ}_{H} \\ sin {θ}_{H} \\ 0\end{matrix} )$$

$$\text{?} \text{indicates text missing or illegible when filed}$$

Here r_{H} may be constant and θ_{H} may be −60°

A construction of an aperture hypothesis 60 is shown in FIG. 27. With this aperture hypothesis 60 a description of an spatial signal as a function of range and angle of incidence may be done.

With the following equation a pseudo target two way path distance may be calculated.

$$d ( k , l ) = {‖ \text{?} - {\vec{p}}_{H} ‖}_{2} + {‖ \text{?} - {\vec{p}}_{H} ‖}_{2}$$

$$\text{?} \text{indicates text missing or illegible when filed}$$

Furthermore a direction of arrival hypothesis may be estimated with the following equation:

$$s ( k , l ) = exp ( - \frac{2 π}{λ} jd ( k , l ) )$$

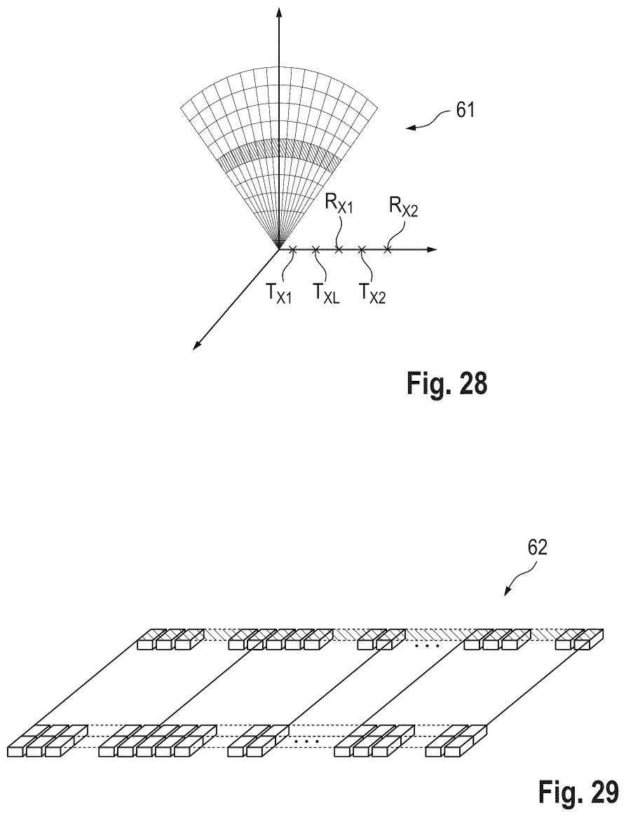

In FIG. 28 is expended hypothesis model 61 shown. The description of FIG. 26 are to be applied here in any case.

In FIG. 29 a aperture hypothesis 62 based on the expended hypothesis model 61 is shown. The description and the calculations of FIG. 27 are to be applied here in any case.

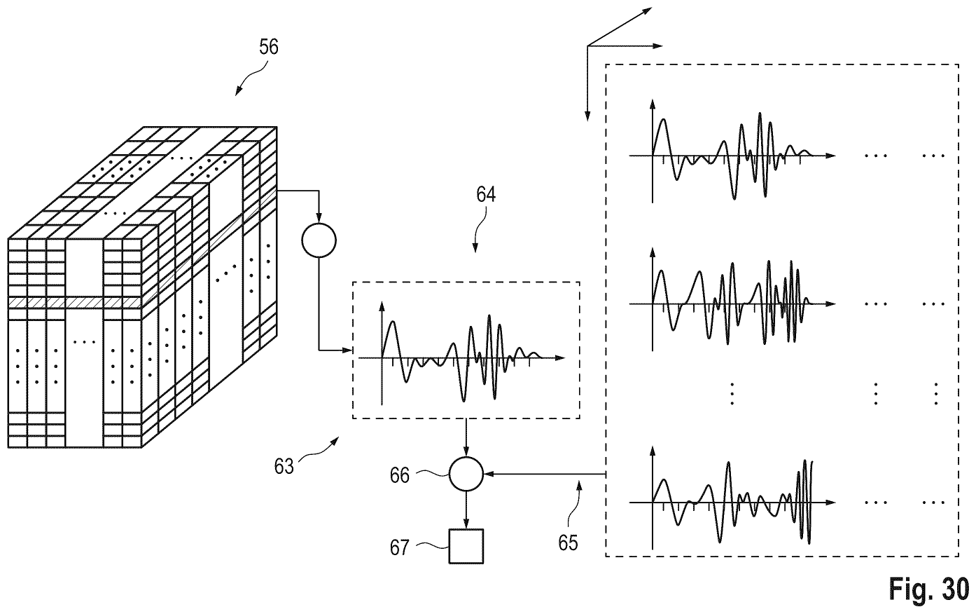

FIG. 30 shows an example control flow how to estimated angle in azimuth and elevation.

As a first input parameter 63 a Doppler compensation of the range matrix 56 may be provided. As a second input parameter 64 the Doppler adjusted aperture signal may be provided. As an example third input parameter 65 an aperture hypothesis may be provided. Based on the input parameters 63, 64, 65 an angle in azimuth and elevation may be estimated with an orthogonal matching pursuit algorithm 66. The angle in azimuth and elevation may be provided as a target information 67 of the radar target 15. This target information 67 may be determined based on the orthogonal matching pursuit algorithm 66 or a compressive sensing algorithm. Particularly may be provided with the target information 67 an angle and/or a direction to the radar target 15.

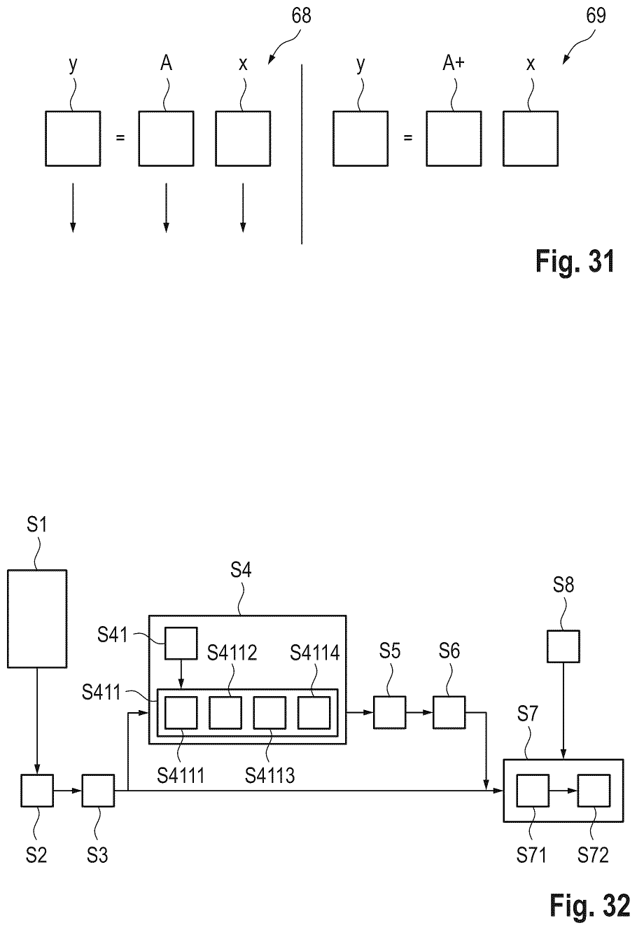

FIG. 31 shows schematic a definition of compressed sensing for angel estimation.

Compressed sensing is based on the principle that, through optimization, the sparsity of a signal may be exploited to recover it from far fewer samples than required by the Nyquist-shannon-sampling-theorem.

Assume a signal is modelled by an underdetermined linear system. Therefore a compressed sensing schema 68 is shown. A original signal X is combined with a sensing matrix A to estimate a compressed signal Y. With a reconstruction schema 69 the original signal X may be reconstructed. For X maybe exists an infinite number of solution. To find a solution one must impose extra constraints and conditions. In Compressed sensing one adds the constraint of sparsity. Here only solutions which have a small number of nonzero coefficients may be allow.

FIG. 32 shows schematic a process flow how to the calculation of a direction of arrival may be done.

In an optional step S1 an input may be calculated based on a two way target distance. For example the input based on 256 ADC-samples multiple with six receiving antennas multiple with eight transmitting antennas multiple with 32 MIMO-cycles.

In an optional step S2 a Hamm windowing range may be calculated. This may takes 62 microseconds.

In an optional step S3 a range fast Fourier transformation (FFT) may be performed. This may takes 400 microseconds.

In an optional step S4 an coherent Doppler processing may be performed. The step S4 may be contains a step S41, in which according to a sensing matrix a direction of arrival compensation may be performed. This may takes 16.2 microseconds.

The step S4 may be contains also a step S411 which is performed after S41. In S411 range-Doppler DoA compensation may be performed. The step S411 may be contains a step S4111, in which a Hamm windowing Doppler may be performed. This may takes 64 microseconds. The step S411 may be contains a step S4112, in which a DoA compensation may be performed. This may takes 8.5 microseconds. The step S411 may be contains a step S4113, in which a Doppler FFT may be performed. This may takes 1.5 microseconds. The step S411 may be contains a step S4114, in which a Doppler compression may be performed. This may takes 4.6 microseconds.

In an optional step S5 a CFAR computing may be performed.

In an optional step S6 a peak detection may be performed.

In an optional step S7 an direction of arrival (DoA) estimation may be performed. The step S7 may be contains a step S71, in which a Doppler compensation may be performed. The step S71 may takes 9 microseconds. The step S7 further may be contains a step S72, in which a OMP computation may be performed.

Step S1 to step S72 may be done or calculate online.

In an optional step S8 a sensing matrix aperture hypothesis may be performed. This may take 251 microseconds and this may be provided for step S7.

Step S8 may be done offline.

The method comprises in other words:
i. Compensation of path mismatch due to paralaxis induced phase shift
ii. Coherent integration of individual receive antenna signals for the determination of the Doppler frequencies
iii. Indication for target identification in each range-Doppler cell
iv. Local aperture signal (snapshot) indexed by range Doppler cell
v. Doppler compensation of local aperture signal as input for orthogonal matching pursuit algorithm (or other compressive sensing algorithms)
vi. Calculation of angular target information

### LIST OF REFERENCE NUMERALS

1 Reception signal
2 Uniform linear antennas
3 Radar system
4 Waveform generator
5 Optical signal
6 Transmitter
7 Receiver
8 Antenna array
9 Transmitting antennas
10 Receiving antennas
11 Low noise amplifier
12 Inphase channel
13 Radar signal
14 Environment
15 radar target
16 Received signals
17 Phase shift
18 Data structure
19 Data structure
20 Data structure
21 Motor vehicle
22 Phase shifts
23 Chirp sequence
24 Field of view
25 Multiple pseudo targets
26 Hypothesis model
27 Pseudo target
28 Data structure
29 Pseudo target
30 Data structure
31 Data structures
32 Pseudo target
33 Data structure
34 Data structure
35 Data structure
36 Pseudo target
37 Data structure
38 Data structure
39 Data structure
40 Pseudo target
41 Data structure
42 Data structure
43 Data structure
44 Range matrix
45 Data structure
46 Data structure
47 Data structure
48 Range-Doppler-map
49 Range-Doppler-map
50 Range-Doppler-map
51 Range-Doppler hypothesis
52 Phase corrected Doppler signals
53 Range-Doppler hypothesis
54 Phase corrected Doppler signals
55 Starting phases
56 Range matrix
57 Different range matrices
58 Range Doppler matrix
59 Field of view
60 Aperture hypothesis
61 Expended hypothesis model
62 Aperture hypothesis
63 Input parameter
64 Input parameter
65 Input parameter
66 Orthogonal matching pursuit algorithm
67 Target information
68 Compressed sensing schema
69 Reconstruction schema
70 Electronic evaluation circuit
71 Following phases
S1-S8 Steps
Tₓ₁ to Tₓ₈ Antenna index

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for determining at least one target information of at least one radar target of a radar system, wherein the radar system comprising at least one antenna array, comprising multiple transmitting antennas and multiple receiving antennas, comprising:
transmitting by each transmitting antenna of the multiple transmitting antennas a radar signal into an environment of the radar system in successive transmission operation;
after each transmitting operation, receiving, by at least some of the plurality of receiving antennas, reflected received signals from the radar target in the environment based on the transmitted radar signal of the respective transmitting operation;
specifying multiple hypothesis of target angles with regards to the radar target;
for each hypothesis of a target angle, generating a data structure based on the received signals, wherein each data structure comprises the received signals which correspond to the hypothesis of the target angle of the respective data structure;
for each generated data structure, generating an individual range-Doppler-map based on the individual received signals of each data structure; and
determining the target information of the radar target based on the range-Doppler-maps of the date structures.

2. The method of claim 1, wherein for each transmission operation the one of the plurality of the transmitting antennas which transmits a radar signal is defined in any order, in particular the one of the plurality of the transmitting antennas which transmits a radar signal in each transmission operation is randomized default.

3. The method of claim 1, wherein multiple pseudo targets are determined based of a respective field of view of each transmitting antenna.

4. The method of claim 3, wherein for each pseudo target a range bin is determined based on the radar signal of the respective transmitting antenna and on a received signal which correspond to the radar signal.

5. The method of claim 4, wherein hypothesis of the directions of arrival of the radar target are determined on the basis of the range bin of the pseudo targets, wherein the multiple hypothesis of target angels are specified based on the hypothesis of the directions of arrival.

6. The method of claim 3, wherein a construction of an aperture hypothesis for each pseudo target is applied based on the respective pseudo target.

7. The method of claim 1, wherein a target detection of the radar target is applied based on a range-Doppler-map of each data structure.

8. The method of claim 1, wherein the received signals of each data structure are coherent combined for determining the range-Doppler-map of each data structure.

9. The method of claim 1, wherein for each range-Doppler-map of the data structures an individual target signal relating to the radar target is generated based on each range-Doppler-map.

10. The method of claim 9, wherein for each range-Doppler-map a Doppler compensation is applied based on a Doppler compensation filter which is based on individual target signal.

11. The method of claim 1, wherein the target information of the radar target is determined based on an orthogonal matching pursuit algorithm or a compressive sensing algorithm.

12. The method of claim 1, wherein with the target information an angle and/or a direction to the radar target is provided.

13. A radar system comprising at least one antenna array, which comprises multiple transmitting antennas and multiple receiving antennas, and an electronic evaluation circuit, wherein the radar system is configured to:
transmit by each transmitting antenna of the multiple transmitting antennas a radar signal into an environment of the radar system in successive transmission operation;
after each transmitting operation, receive, by at least some of the plurality of receiving antennas, reflected received signals from the radar target in the environment based on the transmitted radar signal of the respective transmitting operation;
specify multiple hypothesis of target angles with regards to the radar target;
for each hypothesis of a target angle, generate a data structure based on the received signals, wherein each data structure comprises the received signals which correspond to the hypothesis of the target angle of the respective data structure;
for each generated data structure, generate an individual range-Doppler-map based on the individual received signals of each data structure; and
determine the target information of the radar target based on the range-Doppler-maps of the date structures.

14. A motor vehicle comprising a radar system of claim 13.

15. The motor vehicle of claim 14, wherein the transmitted antennas and the receiving antennas of the antenna array are arranged at a distance from each other on the motor vehicle.

16. The radar system of claim 13, wherein for each transmission operation the one of the plurality of the transmitting antennas which transmits a radar signal is defined in any order, in particular the one of the plurality of the transmitting antennas which transmits a radar signal in each transmission operation is randomized default.

17. The radar system of claim 13, wherein multiple pseudo targets are determined based of a respective field of view of each transmitting antenna.

18. The radar system of claim 17, wherein for each pseudo target a range bin is determined based on the radar signal of the respective transmitting antenna and on a received signal which correspond to the radar signal.

19. The radar system of claim 18, wherein hypothesis of the directions of arrival of the radar target are determined on the basis of the range bin of the pseudo targets, wherein the multiple hypothesis of target angels are specified based on the hypothesis of the directions of arrival.

20. The radar system of claim 17, wherein a construction of an aperture hypothesis for each pseudo target is applied based on the respective pseudo target.
